(19) United States
(12) Patent Application Publication
(10) Pub. No.: US 2007/0108245 A1
(43) Pub. Date: May 17, 2007

(54) DEVICE FOR UP AND DOWN TILTING OF A LOAD CARRIER ATTACHED AT A VEHICLE

(75) Inventors: Magnus FERMAN, Varnamo (SE); Magnus RAGNARSSON, Varnamo (SE)

Correspondence Address: NOVAK DRUCE & QUIGG, LLP, 1300 EYE STREET NW, SUITE 1000 WEST TOWER, WASHINGTON, DC, 20005, US

(73) Assignee: THULE SWEDEN AB, Hillerstorp (SE)

(21) Appl. No.: 11/620,660

(22) Filed: Jan. 6, 2007

Related U.S. Application Data
(63) Continuation of application No. PCT/SE05/01051, filed on Jul. 7, 2005.

(30) Foreign Application Priority Data
Jul. 7, 2004 (SE) SE 0401817-2

(51) Int. Cl. B60R 11/00; B60R 9/00

(52) U.S. Cl. 224/504; 224/924; 224/495; 224/537

(57) ABSTRACT

A tilting load carrier configured to be attached to a carrying vehicle. The load carrier includes a frame having a stationary first part configured to be fixedly attached to a carrying vehicle and a pivoting second part pivotably connected to the first part so that an upper portion of the carrier can be tilted away from the vehicle to provide greater spacing between the upper portion of the load carrier and the carrying vehicle. The carrier includes a load receiver mounted on the frame and configured to receive an article to be transported on the carrying vehicle.

### FIELD

The present technology relates to load carriers. In particular, the present invention relates to a device for tilting a load carrier attached at a vehicle. The load carrier can have a frame which includes a first part firmly connected with a coupling means for fastening at the vehicle, a pivoted second part movably connected with the first part, whereupon the second part includes means in order to carry a load, and a user-actuable, graspable device arranged between said parts, which can be moved from a first engagement position, where the graspable device effectively fastens said parts to each other, to a second position, where said parts can be rotated relative to each other.

### BACKGROUND

Previously known coupling devices for such load carriers as hitch-mount bicycle racks include gripping means that embrace towing balls. Through adapting the force applied to the towing ball an intermediate position can be achieved where the friction against the towing ball is such that the coupling device remains in adjusted position, but is possible to twist the device around the ball by applying an external force. Thus, it becomes possible to tilt the coupling device together with the load carrier to select a less intrusive location for the load carrier. This can allow easier access to space in the vehicle. One known disadvantage of previously known devices is that the entire load carrier must tilt together with the tilting of the coupling device. Moreover, as wearing of the tow ball occurs it can become difficult to achieve sufficient friction against the ball. Another disadvantage with this solution and similar known solutions is that it can be difficult to access the devices that operate the gripping means when the load carrier is carrying a load (e.g. several bicycles, a box and the like).

### SUMMARY

The present technology provides for a device that enables a user to quickly and easily tilt a hitch-mount load carrier, particularly when the load carrier is carrying a load such as sports equipment or other cargo. Moreover, the up and down transition between tilted and untilted positions is to be performed in a simple and controllable way by the operator. The present solution overcomes disadvantages of known carriers by providing a device having a user graspable and actuable device associated with a second part, where the graspable device includes at least a portion that is shaped as a handle, and operation of the graspable device essentially controls actuation (capability for moving) the load so that tilting can be performed in a simple and controllable manner.

### BRIEF DESCRIPTION OF THE DRAWINGS

The invention is described herein below with reference to a preferred embodiment, shown in the accompanying figures in which:

FIG. 1 is a perspective view of a load carrier configured according to the teachings of the present invention;

FIG. 2 is a side view, shown in cross-section of the load carrier in an upright position with the support or graspable device engaged;

FIG. 3 is a side view, shown in cross-section of the load carrier in the tilted position; and

FIG. 4 is a detailed view shown in partial cross-section of a portion of the load carrier.

### DETAILED DESCRIPTION

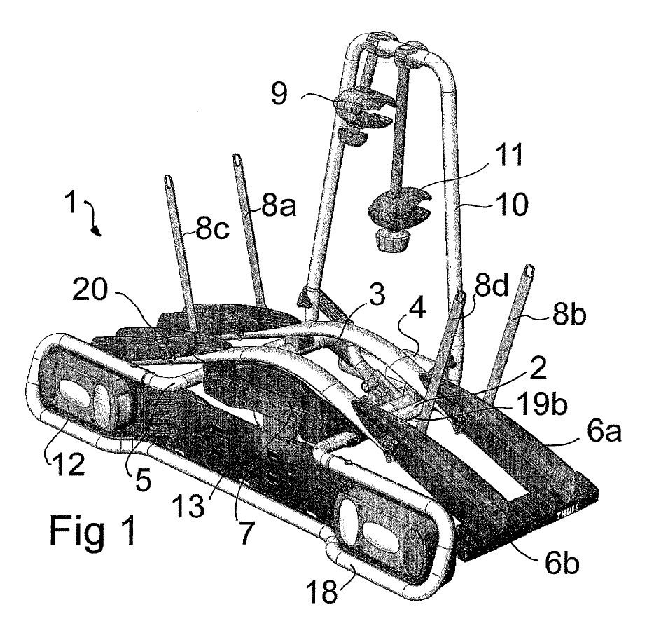

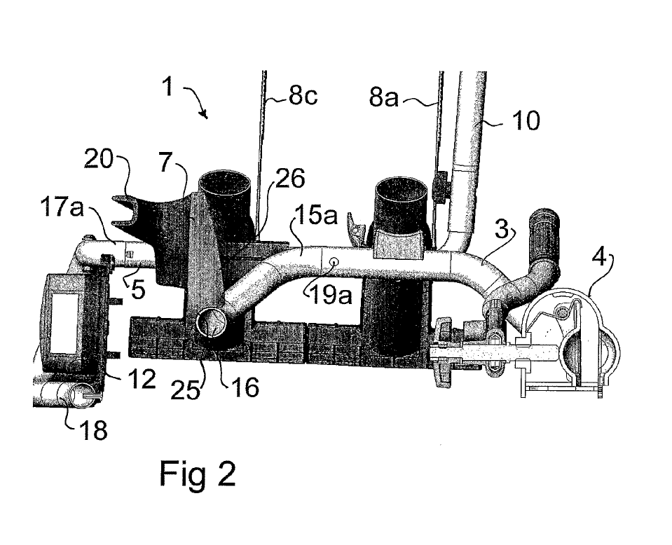

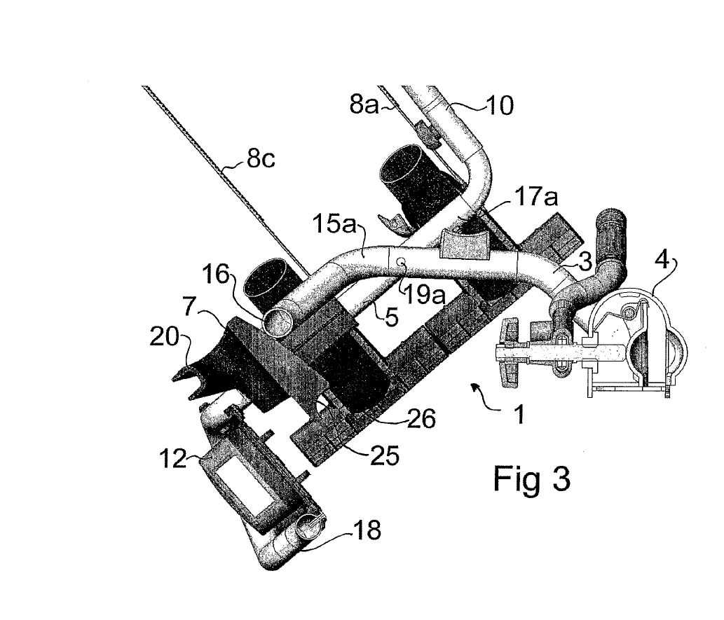

Referring to FIG. 1, a load carrier 1 is shown having a frame 2 including a stationary first part 3 firmly connected with a coupling mechanism 4. Coupling mechanism 4 is for fastening load carrier 1 at a vehicle. Frame 2 further includes a pivoting second part 5 which is movably connected to first part 3. Second part 5 may further include holders or load receivers 6a, 6b that are configured to receive and carry some type of a load. A fastening mechanism including a graspable device 7 is slidably connected to second part 5 for fastening second part 5 to first part 3 in an upright position. Graspable device 7 can slide from a first engagement position (see FIG. 2) where graspable device 7 fastens parts 3 and 5 to each other, to a second position (see FIG. 3) where the parts 3 and 5 are pivotally turned relative to each other. In this regard, it should be appreciated that fastening of the two parts can include the support of the pivoting second part 5 on the stationary first part 3 via the fastening mechanism having parts thereof interposed between the parts 3 and 5 when in the carrier 1 is in the raised an supported position or configuration.

The load carrier 1 shown in FIGS. 1-4 is suitable for securing two bicycles, but the load carrier can be adapted for only one bicycle or several bicycles. The load carrier 1 can also be configured to carry other loads such as boxes, luggage carriers, ski carriers and the like.

Referring to FIG. 1, one bicycle can be placed on holder 6a and is secured with fastening devices 8a and 8b, and a grabbing device 9. Grabbing device 9 is attached to an arc 10 that extends essentially perpendicular upwards from second part 5. Another bicycle can be secured in a likewise manner to holder 6b with the fastening devices 8c and 8d, and a grabbing device 11. Thus, the fastening devices 8a, 8b, 8c, and 8d are fitted to allow for securing at the wheels of the bicycle (not shown) and grabbing devices 9 and 11 are fitted to allow for securing at the framework of the bicycle (not shown). Load carrier 1 may also have an illumination panel 12, with fasteners 13 for a license plate (not shown).

Frame 2 and arc 10 are preferably made of aluminum tubing with a circular profile or other appropriate profile. Holders 6, fastening devices 8, and similar components are preferably made of plastic. Of course, other choices of suitable materials are within the scope of the present technology.

FIGS. 2-4 demonstrate the transitional tilting operation of load carrier 1. FIGS. 2-3 are of a cutaway load carriers viewed from the inside of the device. The tilting operation of load carrier 1 is achieved by pivotally actuating second part 5 about first part 3. First part 3 is constituted at least partially by an essentially rectangular, arched framework, having an inner side 14, two parallel tubes 15a and 15b, and an outer side 16. Inner side 14 is attached to coupling mechanism 4 and extends out on a first lower level. From inner side 14 two parallel tubes 15a and 15b extend in the shape of an arc up to a second upper level and in the general intended direction of travel. Parallel tubes 15a and 15b are linked to an outer side 16 that extends on the lower level, and which completes the essentially rectangular shape of first part 3.

Second part 5 includes a framework comprised partly of two parallel tubes 17a and 17b. In certain embodiments second part 5 further includes a rear framework 18 and arc 10. In one embodiment, rear framework 18 and arc 10 act as the respective outer and inner sides of second part 5. When load carrier 1 is fastened in an upright position, tubes 17a and 17b are level with, and next to, tubes 15a and 15b. Adjacent tubes 15a and 17a are pivotally attached to each other with hinge 19a, while tubes 15b and 17b, are pivotally attached to each other with the hinge 19b.

Graspable device 7 is designed with a handle 20 for accommodating user operation. Graspable device 7 extends partly between parallel tubes 17a and 17b and also partially about outer side 16 when the load carrier 1 is in an engaged position (see FIG. 2). Graspable device 7 may further have recesses 21 formed on each side which parallel tubes 17a and 17b run through; i.e., tubes 17a and 17b can be partially cradled or enclosed by graspable device 7. Thus, graspable device 7 can slide along parallel tubes 17a and 17b.

Preferably, parallel tubes 17a and 17b include a spring 22 and a connecting mechanism 23. In one embodiment, connecting mechanism 23 is in the form of a pin or other similar mechanism and is anchored at graspable device 7. An extended groove 24 (e.g. a slit) can be formed in tubes 17a and 17b, and connection mechanism 23 can be placed within extended groove 24 and slide freely therein. Graspable device 7 also has a gripping recess 25, which essentially fastens second part 5 to outer side 16.

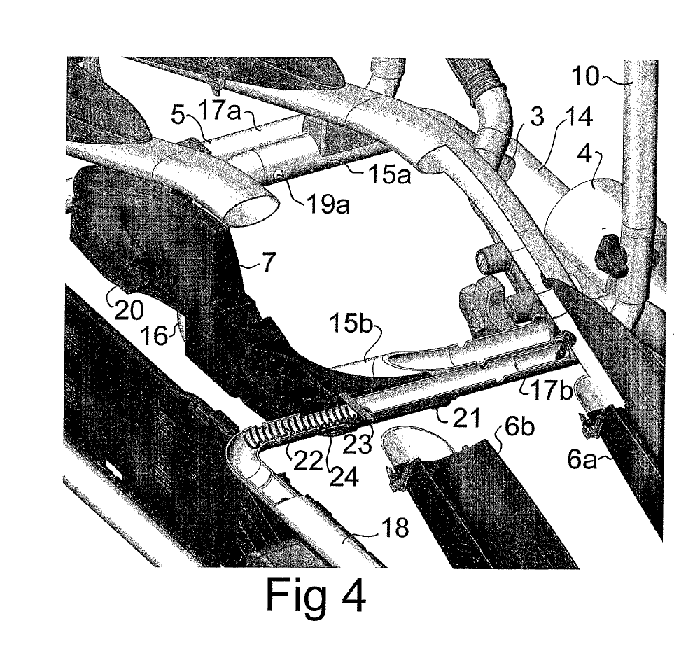

When a user wishes to tilt load carrier 1 down, graspable device 7 is pushed (or pulled) backward, against the intended travel direction of the vehicle in the illustrated example. The handle 20 is used to impose the pushing or pulling of graspable device 7 by the operator. When pushed (or pulled), graspable device 7 slides backward along tubes 17a and 17b. Sliding graspable device 7 also compresses spring 22. Upon sliding, gripping recess 25 is moved from engagement with outer side 16 of first part 3, and then second part 5 can be actuated downward about hinges 19a and 19b. In this embodiment, the gripping recess 25 serves to engage the outer side 16 in a supporting manner which acts to keep the pivoting second part 5 of the frame 2 in a raised position, without necessarily affecting an actual locking of the two parts 3, 5 together. That is, the weight of the pivotable second part 5, together with that of any load received thereupon, is supported by the fastening device, via the graspable member 7 portion thereof which is interposed between the two parts 3, 5 when the load carrier 1 is in the raised configuration (see FIGS. 2 and 4).

During actuation, the load is controlled by the user through the graspable device 7 and whereupon tilting down can take place in a simple and controllable manner.

When tilting the load carrier 1 up to the raised position, the handle 20 of the graspable device 7 is taken a hold of by the operator and lifted, together with any load being carried thereupon. An oblique surface 26 of graspable device 7 abuts against outer side 16 under the force of spring 22; when second part 5 is lifted and gripping recess 25 is level with outer side 16, the spring force will press gripping recess 25 into engagement with outer side 16. Spring 22 maintains this engagement during vehicle travel, whereupon graspable device 7 together with first part 3 and second part 5 keep load carrier 1 in an upraised position.

One development of the presently disclosed solution can be described as a tilting load carrier 1 configured to be attached to a carrying vehicle. The load carrier includes a frame 2 having a stationary first part 3 configured to be fixedly attached to a carrying vehicle and a pivoting second part 5 pivotably connected to the first part so that an upper portion 10 of the carrier can be tilted away from the vehicle to provide greater spacing between the upper portion of the load carrier and the carrying vehicle. The carrier includes a load receiver 6 mounted on the frame and configured to receive an article to be transported on the carrying vehicle. A fastening mechanism 7 is slidably interconnected on the pivoting second part and operator-transitionable between a latched configuration in which the pivoting second part is supported on the stationary first part by the fastening mechanism with the pivoting second part supported in a raised position and a released configuration in which the pivoting second part is allowed to pivot substantially freely relative to the stationary first part between the raised and a lowered position. The fastening mechanism has a graspable handle 20 configured for being grasped by a user and for supporting a full pivot-weight of the pivoting second part and any article carried in the load receiver when the pivoting second part is being pivoted between the raised and lowered positions.

This detailed description is set forth only for the purposes of illustrating examples of the presently disclosed device and should not be considered to limit the scope of the patent claims in anyway. Clearly, numerous additions, substitutions, and other modifications can be made to preferred embodiments without departing from the scope of the invention which is defined exclusively by the patent claims.

1. A tilting load carrier configured to be attached to a carrying vehicle, said load carrier comprising:
a frame comprising a stationary first part configured to be fixedly attached to a carrying vehicle and a pivoting second part pivotably connected to the first part so that an upper portion of the carrier can be tilted away from the vehicle to provide greater spacing between the upper portion of the load carrier and the carrying vehicle;
a load receiver mounted on said frame and configured to receive an article to be transported on the carrying vehicle; and
a fastening mechanism slidably interconnected on said pivoting second part and operator-transitionable between: (i) a latched configuration in which said pivoting second part is supported on said stationary first part by said fastening mechanism with said pivoting second part supported in a raised position and (ii) a released configuration in which said pivoting second part is allowed to pivot substantially freely relative to said stationary first part between the raised and a lowered position, said fastening mechanism having a graspable handle means configured for being grasped by a user and for supporting a full pivot-weight of said pivoting second part and any article carried in said load receiver when said pivoting second part is being pivoted between the raised and lowered positions.

2. The load carrier as recited in claim 1, wherein said stationary first part comprises an essentially rectangular, arched framework having an inner side anchored at a vehicle attachment mechanism of the load carrier.

3. The load carrier as recited in claim 2, wherein said essentially rectangular, arched framework comprises two parallel lateral tubes that each extend in an upwardly directed arch.

4. The load carrier as recited in claim 3, wherein said essentially rectangular, arched framework comprises an outer side member extending between said two lateral parallel tubes.

5. The load carrier as recited in claim 4, wherein said pivoting second part comprises a framework comprising two parallel lateral tubes, that in the raised position are level with and adjacent to said two parallel lateral tubes of said stationary first part.

6. The load carrier as recited in claim 5, wherein said graspable handle means extends at least partly between said two parallel lateral tubes of said pivoting second part.

7. The load carrier as recited in claim 5, wherein said graspable handle means further comprises a pair of recesses through which one each of said two parallel lateral tubes of said pivoting second part extend.

8. The load carrier as recited in claim 7, wherein said graspable handle means is slideably configured on one of said two parallel lateral tubes of said pivoting second part extend.

9. The load carrier as recited in claim 8, wherein said two parallel lateral tubes of said pivoting second part comprise a spring interconnected therewith by a connector anchored at the graspable handle means.

10. The load carrier as recited in claim 9, wherein said connector is glidingly retained in a groove in said one of said two parallel lateral tubes of said pivoting second part.
